(19) United States
(12) Patent Application Publication
(10) Pub. No.: US 2020/0258149 A1
(43) Pub. Date: Aug. 13, 2020

(54) TRANSPARENT INTERNATIONAL CROWDFUNDING SYSTEM

(71) Applicant: John Wingood Beach, III, Clarksville, TN (US)

(72) Inventors: Robert M. Evans, SR., Chautauqua, NY (US); John Wingood Beach, III, Clarksville, TN (US)

(21) Appl. No.: 16/785,511

(22) Filed: Feb. 7, 2020

Related U.S. Application Data
(60) Provisional application No. 62/802,524, filed on Feb. 7, 2019.

(51) Int. Cl. G06Q 40/02; G06Q 40/06

(52) U.S. Cl. CPC G06Q 40/025; G06Q 40/06

(57) ABSTRACT

Systems and methods receive details of loans requested by borrowers and displays the loan details on websites viewed by potential investors and/or donors. Investments and donations in response to the loan requests are tracked and repayments by individual borrowers are tracked and made available to the investors and/or donors. This transparency is available to investors and donors in real-time and allows the investor and donor to view performance of the investment and use of the loan at an individual borrower level. An Application Programming Interface (API) enables the systems and methods to push and pull loan information from financial institution loan management servers, and allows investors to directly fund one or more financial institutions, which in turn may then use the fund to provide local loans.

### RELATED APPLICATION

This application claims priority to U.S. Patent Application Ser. No. 62/802,524, titled “Transparent International Crowdfunding System,” filed Feb. 7, 2019, which is incorporated herein by reference in its entirety.

### BACKGROUND

Investors investing in, or donating funds to, third world countries, such as Africa, are typically unaware of how their funds would be used, and are uninformed of investment repayment performance in any detail via connectivity with an investor's computer at any location having an Internet connection. Loan administrators in the third world country often track loans, borrowers, and repayments using paper based methods, and do not have means for disseminating detailed transparent information to investors.

### SUMMARY

One aspect of the present embodiments includes the realization that potential investors are more hesitant to invest without visibility of how funds are used and how repayments are made. The present embodiments solve this problem with a cloud-based server that interacts with loan administrators to receive details of requested loans and borrowers. The server displays details of the loan on websites viewed by potential investors and/or donors and tracks investments and donation payments made in response to the loan. The server also interacts with the loan administrator to track repayments by individual borrowers to the loan and makes this information available to the investors and/or donors. This transparency is available to investors and donors in real-time and allows the investor and donor to view performance of the investment and use of the loan at an individual borrower level. Advantageously, this transparency in detail allows potential investors (typically small investors or individuals) to evaluate information of the borrower and intended use for the money before deciding whether to invest, and allows the investor and/or donor, once invested/donated to evaluate a particular loan administrator's performance at the individual borrower level in getting the loan repaid. Such information allows the investor/donor to decide on further investments/donations through that loan administrator and direct funds away from non-performing loan borrowers and to performing loan clients.

A second aspect of the present embodiments includes the realization that larger investors are more reluctant to invest in a third world country when only high-level investment performance information is available. The present embodiments solve this problem by providing a system that interacts with both the investors and the loan administrators to make information of individual borrowers and their repayments available to investors. The loan administrator enters information of borrowers and/or investees directly into the system, and the system makes this information available to the investors transparently.

A third aspect of the present embodiments includes the realization that some financial institutions (e.g., banks, credit unions, etc.) in third world countries are using loan management servers and loan management software (e.g., software from third party software companies) to manage loans locally at the financial institution, and that these servers and software are already known to, and functioning well for, the financial institutions. Accordingly, the financial institutions are less willing to switch to, and learn, new loan management software (e.g., loan administrator portal 112). The present embodiments solve this problem by providing an Application Programming Interface (API) to push and pull loan information from financial institution loan management servers, and by allowing investors to directly fund one or more financial institutions, which in turn may then use the fund to provide local loans.

In one embodiment, a system for transparent international crowdfunding of loans by a financial institution, includes: at least one processor; a memory, communicatively coupled with the processor; an investor portal, having machine-readable instructions stored in the memory and executed by the processor, that causes the processor to: receive loan data from a server of the financial institution in a first country via an application programming interface (API); determine a fund based upon the loan data; implement a web interface, displaying details of the fund, that is accessible via the Internet by at least one investor in a second country, different from the first country; and receive an investment for the fund from the at least one investor.

In another embodiments, a method for transparent international crowdfunding, includes: receiving, via an application programming interface (API) implemented as machine-readable instructions executed by a processor of a server, loan data defining a loan amount and identifying at least one borrower responsible for the loan amount; displaying, via an investor portal implemented as machine-readable instructions executed by the processor, the investment opportunity on a website in a second country; receiving, via the investor portal, funds from an investor for the loan; receiving, via the API, loan repayment information for the at least one borrower; displaying, via the investor portal, the loan repayment information; and displaying, via the investor portal, performance statistics of the loan administrator.

In another embodiments, a method for transparently enabling a non-profit organization based in a first country to view loan repayment information and loan performance information for a loan funded by the non-profit organization through a financial institution in a second country, includes: receiving, via an application programming interface (API) implemented as machine-readable instructions executed by a processor of a server, loan data including the loan repayment information of at least one borrower associated with the loan; displaying, via an investor portal implemented as machine-readable instructions executed by the processor, the loan repayment information on a website accessible by the non-profit organization; calculating the loan performance information using the loan data and the loan repayment information; and displaying, via the investor portal, the loan performance information. The loan repayment information and the loan performance information being accessible at any point in time, including in real time, on a computer of the non-profit organization located in the first country.

### BRIEF DESCRIPTION OF THE FIGURES

FIG. 1 shows one example system for transparent international crowdfunding, in embodiments.

FIG. 2 shows example data flow into and out of the system of FIG. 1, in embodiments.

FIGS. 3-5 show example screenshots generated by the server of FIG. 1 when accessed by an investor, in embodiments.

FIG. 6 is a screenshot showing a dashboard graphical user interface as displayed to a super-admin, in embodiments.

FIG. 7 is a screenshot including a table of loan applications resulting from the search of FIG. 6, in embodiments.

FIGS. 8-10 are screenshots showing a new application page that allows a loan administrator to input details of a new loan application into the system of FIG. 1, in embodiments.

FIGS. 11 and 12 are screenshots of a loan repayment page that may be displayed once the corresponding loan has issued, in embodiments.

FIG. 13 is a screenshot showing a repayment pop-up that allows a loan administrator to enter repayment details for the corresponding loan, in embodiments.

FIG. 14 is a screenshot of a repayment history pop-up box displaying a history of repayments made by one individual of a group, in embodiments.

FIGS. 15-17 are screenshots showing example detail of the repayment metrics for the loan, in embodiments.

FIG. 18 is a screenshot showing a table of historical records for each repayment made to the corresponding loan, in embodiments.

FIG. 19 shows one example repayment record, in embodiments.

FIG. 20 is a flowchart illustrating one example method for transparent international crowdfunding, in embodiments.

FIG. 21 shows one example system for transparent international crowdfunding, in embodiments.

FIG. 22 is an example screenshot generated by the investor portal of FIG. 21, showing example detail of one financial institution to be funded by online investors, in embodiments.

FIG. 23 is an example screenshot, generated by the investor portal of FIG. 21, showing an investor dashboard that conveying progress and performance of funds corresponding to one investor, in embodiments.

FIG. 24 is an example landing page, generated by the inventor portal of FIG. 21, displaying three financial institution-level funds being marketed to investors, in embodiments.

FIG. 25 is an example screenshot, generated by the system of FIG. 21, showing a super-admin dashboard illustrating approval of a fund applied for by the ABC bank in Malawi, in embodiments.

FIG. 26 is an example screenshot showing the super-admin dashboard of FIG. 25 illustrating rejection of the fund applied for by the ABC bank in Malawi, in embodiments.

FIG. 27 is a high-level block diagram of the system of FIG. 21 interfacing with a banking software provider to fund loans through one or more financial institutions, in embodiments.

### DETAILED DESCRIPTION OF THE EMBODIMENTS

In third world countries, such as Africa, borrowers desire to receive loans to fund projects. Investors in other countries, desire to invest or donate funds, but for investment in third world countries, are typically unaware of how their funds would be used, and are uninformed of investment repayment performance in any detail via connectivity with an investor's computer at any location having an Internet connection. Particularly, loan administrators in the third world country often track loans, borrowers, and repayments using paper based methods, and do not have means for disseminating detailed transparent information to investors.

In one aspect of embodiments described herein, a cloud-based server interacts with loan administrators to receive details of requested loans and borrowers. The server displays details of the loan on websites viewed by potential investors and/or donors and tracks investments and donation repayments made in response to the loan. The server also interacts with the loan administrator to track repayments by individual borrowers to the loan and makes this information available to the investors and/or donors. This transparency is available to investors and donors in real-time and allows the investor and donor to view performance of the investment and use of the loan at an individual borrower level. Advantageously, this transparency allows potential investors (typically small investors or individuals) to evaluate information of the borrower as well as intended use for the money in detail before deciding whether to invest. Transparency also allows the investor and/or donor, once invested/donated, to evaluate a particular loan administrator's performance at the individual borrower level in getting the loan repaid. Such information allows the investor/donor to decide on further investments/donations through that loan administrator and direct funds away from non-performing loan borrowers and to performing loan clients.

A second aspect of the embodiments described herein includes transparently providing information to larger investors. Prior to the embodiments described herein, a larger investor is often unaware how provided funding is used, seeing only overall performance of the fund. The embodiments described herein overcome this problem by providing a system that interacts with both the investors and the loan administrators, and making information of individual borrowers and their repayments available to investors. That is, the loan administrator enters information of borrowers and/or investees directly into the system, and the system makes this information available to the investors transparently.

The following examples illustrate embodiments where the investors and the borrowers are in different counties. However, the present embodiments may operate independently of investor and borrower location (e.g., allowing investors and borrowers to be in the same country).

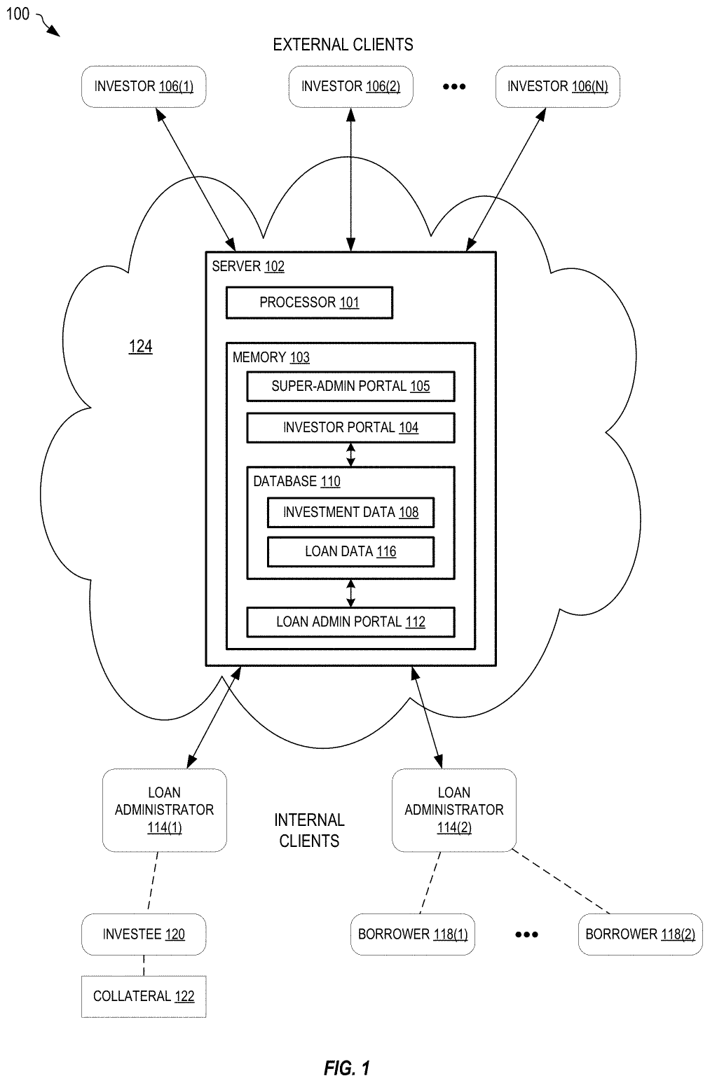

FIG. 1 shows one example system 100 for transparent international crowdfunding. System 100 includes a server 102 implemented within the cloud (e.g., connected to and accessible via, the Internet) that includes at least one processor 101 and memory 103. The memory 103 stores machine-readable instructions (e.g., software) that when executed by the processor 101 implement a super-admin portal 105 for interacting with a super-admin user, an investor portal 104 for interacting with investors 106 (and potential investors) to collect and store investment data 108 in a database 110, and a loan administrator portal 112 for interacting with loan administrators 114 (e.g., an administrator at a financial institution, such as a bank, a micro-financial institution (MFI), a savings and credit cooperative (SACCO), a credit union, etc.). Loan administrators 114 collect loan data 116 from one or more borrowers 118 and/or investees 120 (with collateral 122) and interact with loan administrator portal 112 to enter and store loan data 116 in database 110. In certain embodiments, the investor portal 104 may provide an investor dashboard and loan administrator portal 112 may provide a loan administrator dashboard. Investor portal 104 and loan administrator portal 112 may implement a web interfaces and/or web site that are accessible via the Internet 124, for example.

Advantageously, system 100 may provide certain information from loan data 116 via investor portal 104 to investors 106 making the investor dashboard more transparent as compared to conventional crowdfunding systems. For example, investor 106 may view details of borrower 118 and investee 120 and is therefore more aware of how the investment money is being used and paid back. Such information may be invaluable for securing an investment from investor 106, particularly when investor 106 and borrower 118 are in different countries.

Super-admin portal 105 allows the “super-admin” user (e.g., a non-financial user but administrator of operations of system 100) to access and correct information of system 100. For example, the super-admin user may interact with super-admin portal 105 to review and approve funding of loans. The super-admin user may also interact with investor portal 104 from an investor perspective and interact with loan administrator portal 112 from a loan administrator perspective. That is, the super-admin user is unbiased towards internal clients (e.g., loan administrators 114) and external clients (e.g., investors 106) when viewing and/or changing information. The following example screenshots show information from the perspective of the super-admin user and are therefore equivalent to screenshots viewable by a highest-level loan administrator 114 (e.g., a MFI user) and screenshots viewable by an investor 106. The super-admin user may also manage accounts of loan administrators 114, which may be operated by one of an MFI, a non-government organization (NGO), non-profit organization, or a SACCO.

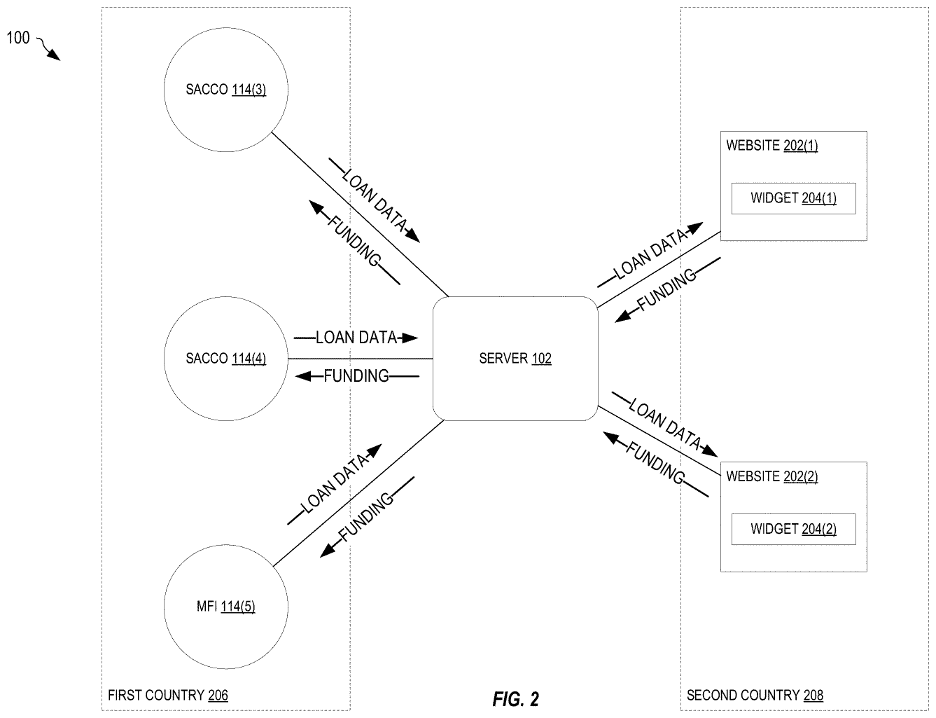

FIG. 2 shows example data flow into and out of system 100. In this scenario, system 100 receives loan data 116 from two SACCO loan administrators 114(3) and 114(4) and an MFI loan administrator 114(5) located in a first country 206. For example, system 100 provides functionality that allows loan administrators 114 to capture relevant information from borrowers and investees. System 100 makes loan data 116 available to potential investors (e.g., investors 106) via one or more websites 202 in a second country 208. Particularly, server 102 may communicate with a widget 204 that may be included with website 202 to facilitate display of loan data 116 to investors in a second country. Accordingly, a partner (e.g., an investment company) of system 100 may easily display information of loan data 116 on website 202 to attract investment by investors 106. As appreciated, loan administrators 114 could be located in additional countries, and websites 202 could be located in additional countries, without departing from the scope hereof.

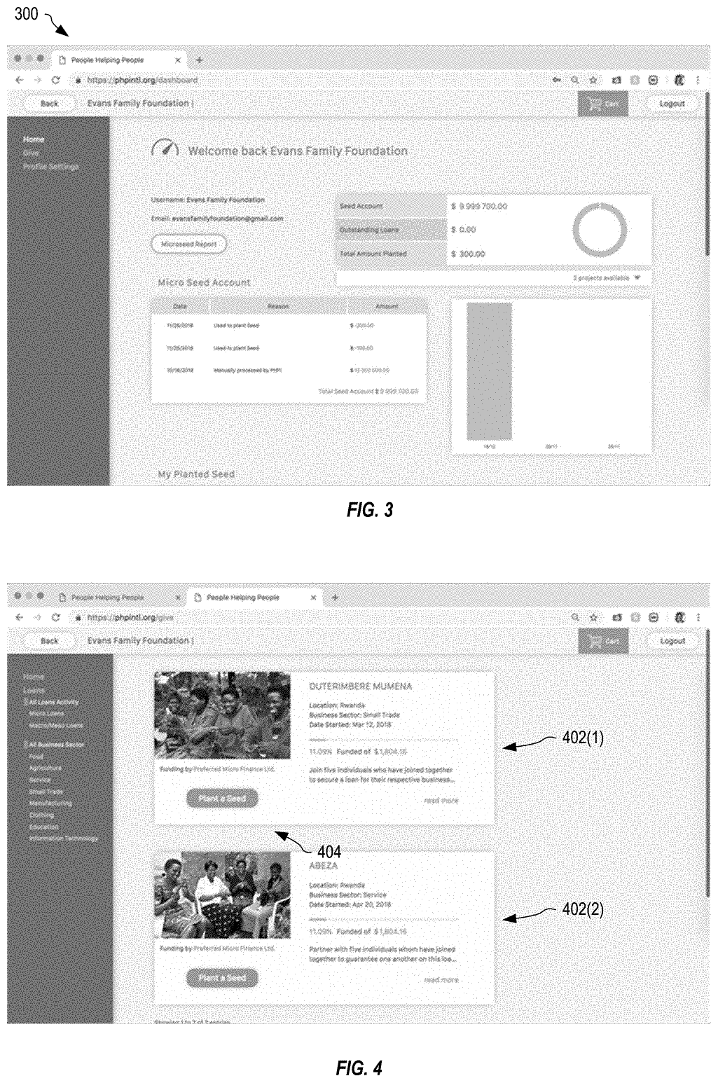

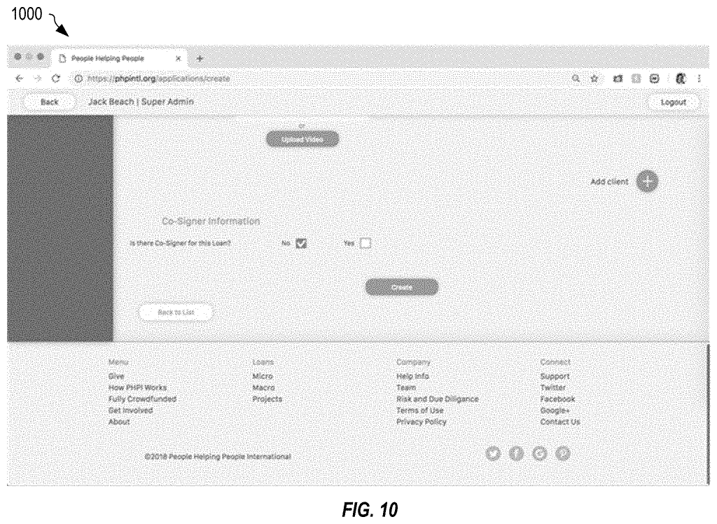

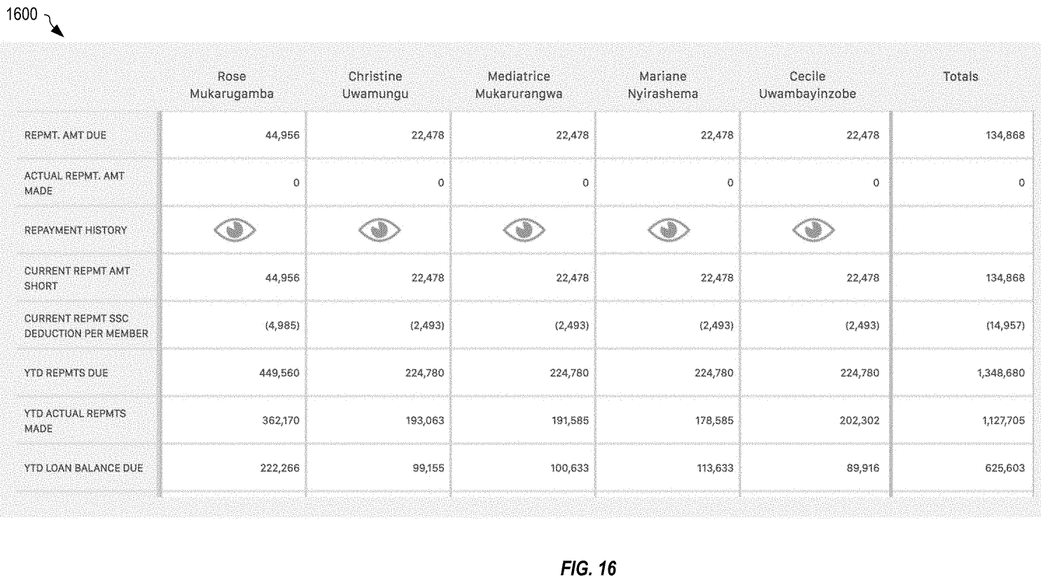

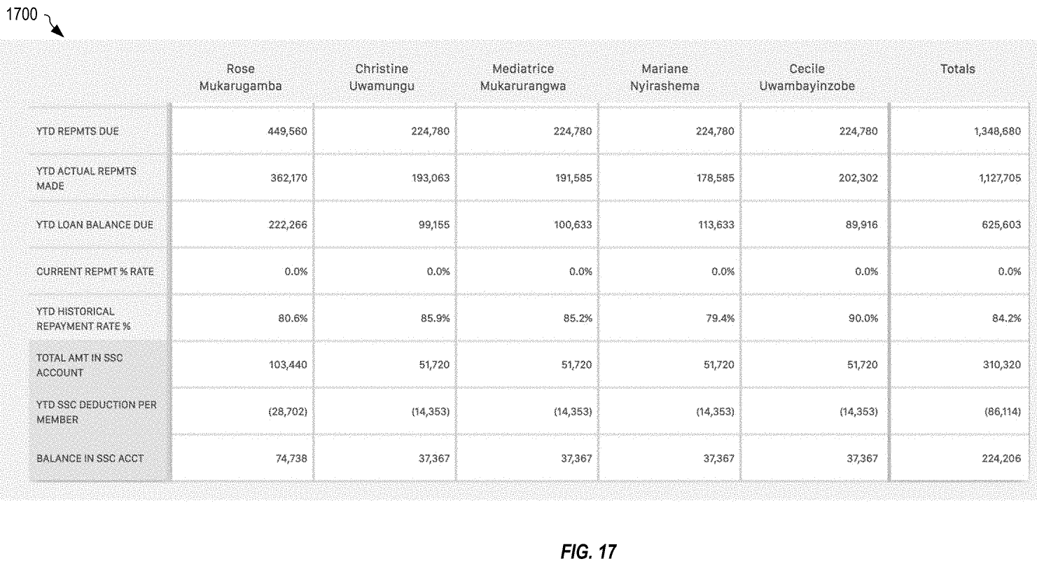

Users of system 100 may use a login name and password to access server 102, and thereby server 102 determines the type of the user and accordingly, the information that may be accessed. Loan administrators 114 may be referred to as internal clients, and investors 106 (e.g., donors/special investors) may be referred to as external clients. FIGS. 3-19 are example screenshots, or portions thereof, showing unique cloud-based functionality provided by server 102 when accessed via a browser on desktop or laptop with an internet connection. When loan administrators 114 operate outside of a network connection they may use a software application running on a mobile device to collect loan data 116 (e.g., new applications or repayments) offline, such that this information may be imported to system 100 when the mobile device later connects to server 102.

FIGS. 3-5 show screenshots generated by server 102 when accessed by investor 106 (in this case a special investor). The information displayed by system 100 to investors 106 is unique in the level of transparency provided. Advantageously, since server 102 collects loan data 116 in detail from loan administrators 114, server 102 may make at least some of that data available to investors 106. FIG. 3 shows an example dashboard 300 displaying an overview of the investments made by investor 106, including a virtual credit account indicating investor funds not invested, an outstanding loan amount indicating the money owed to investor 106, and a total amount of investment money invested by investor 106. FIG. 4 shows two example investment opportunities 402(1) and 402(2) available to the investor 106, each allowing the investor to display further information on the loan that forms the basis of the investment opportunity, and to select a “Plant a Seed” button 404 to make an investment.

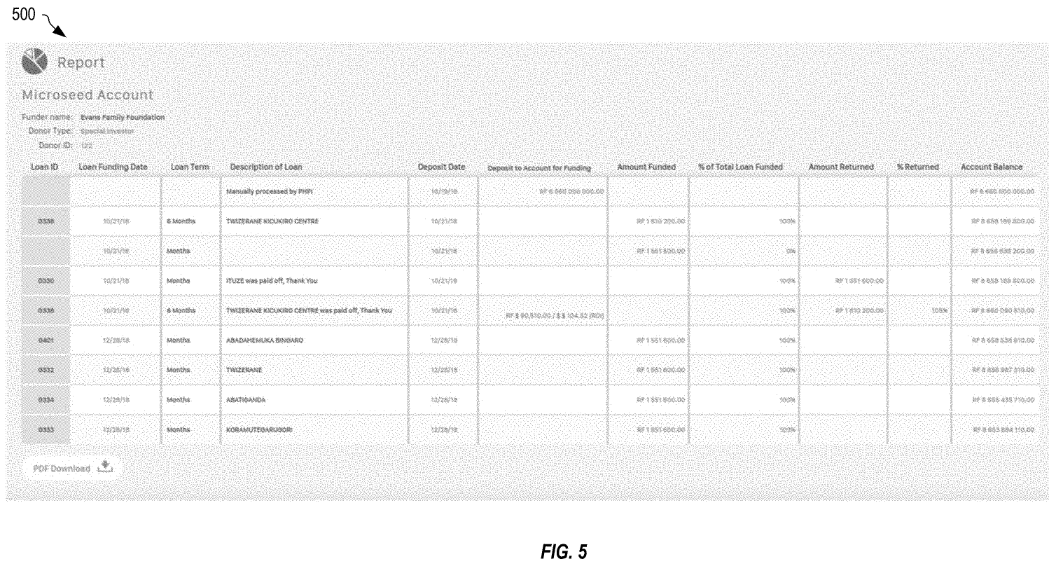

FIG. 5 shows an example report 500 for a microseed account of investor 106 illustrating loans funded by the investor and illustrating status of each loan into which investment has been made. Information being displayed to investor 106 by system 100 is collected from loan administrators 114.

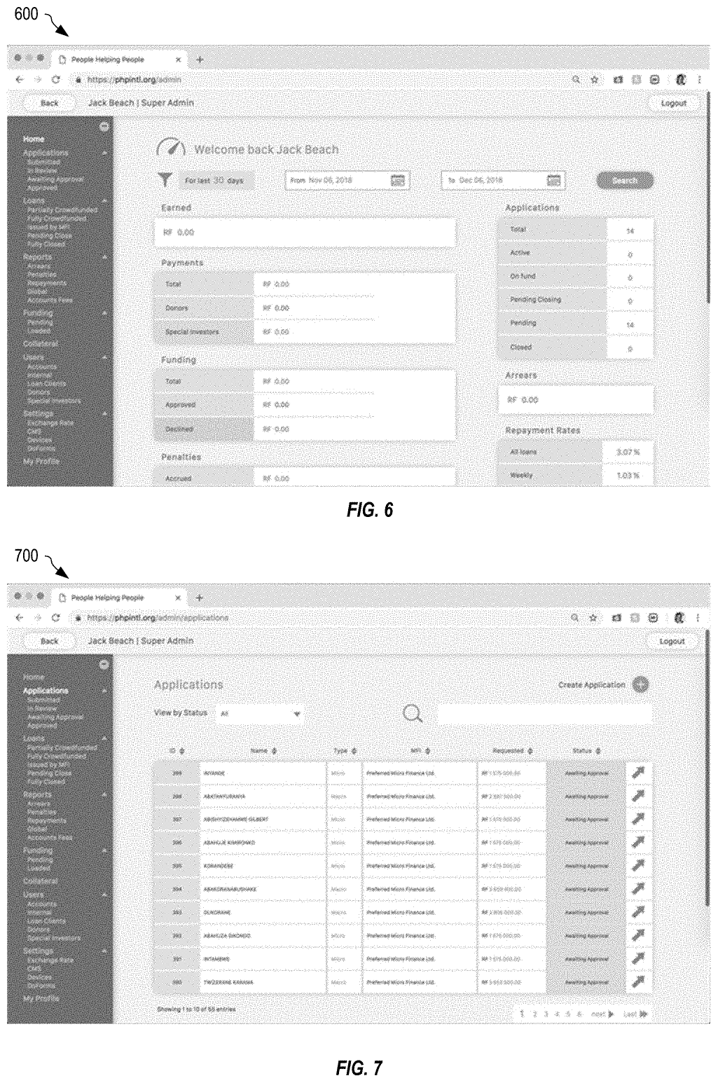

FIGS. 6-19 are example screenshots generated for a “super-admin” account (e.g., an administrator of system 100 and/or server 102). The super-admin user may view and edit all aspects of system 100 as a non-financial user. That is, the super-admin user administers system 100 and/or server 102 and may facilitate changes that are needed to the software and/or data. Accordingly, these screenshots show information available to a highest-level role of loan administrator 114. Within system 100, each loan administrator 114 has an ‘Account’. Loan administrator 114 need not be an MFI, but may also be a non-government organization (NGO) or a savings & credit cooperative (SACCO). Accordingly, each of these loan administrators 114 may also be referred to as an “Account” in the following examples.

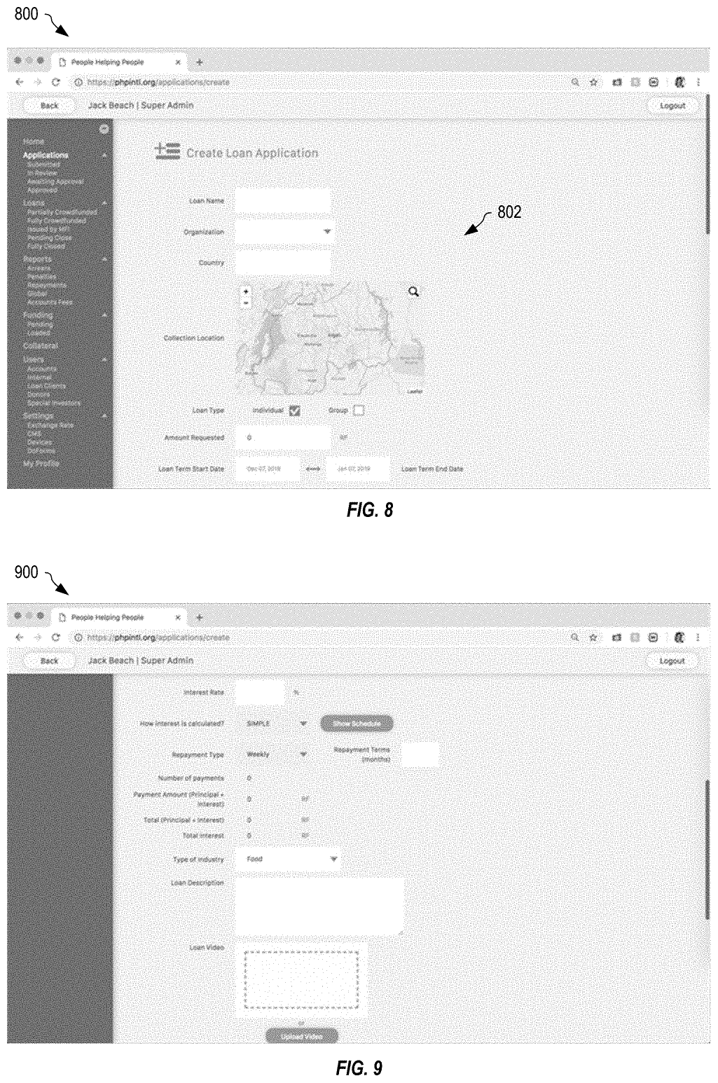

FIG. 6 is a screenshot 600 showing the super-admin searching for new loan applications. FIG. 7 is a screenshot 700 of a table identifying loan applications resulting from the search of FIG. 6. FIGS. 8-10 are screenshots 800, 900, and 1000, respectively, showing a new application page 802 that allows loan administrator 114 to input details of a new loan application into system 100.

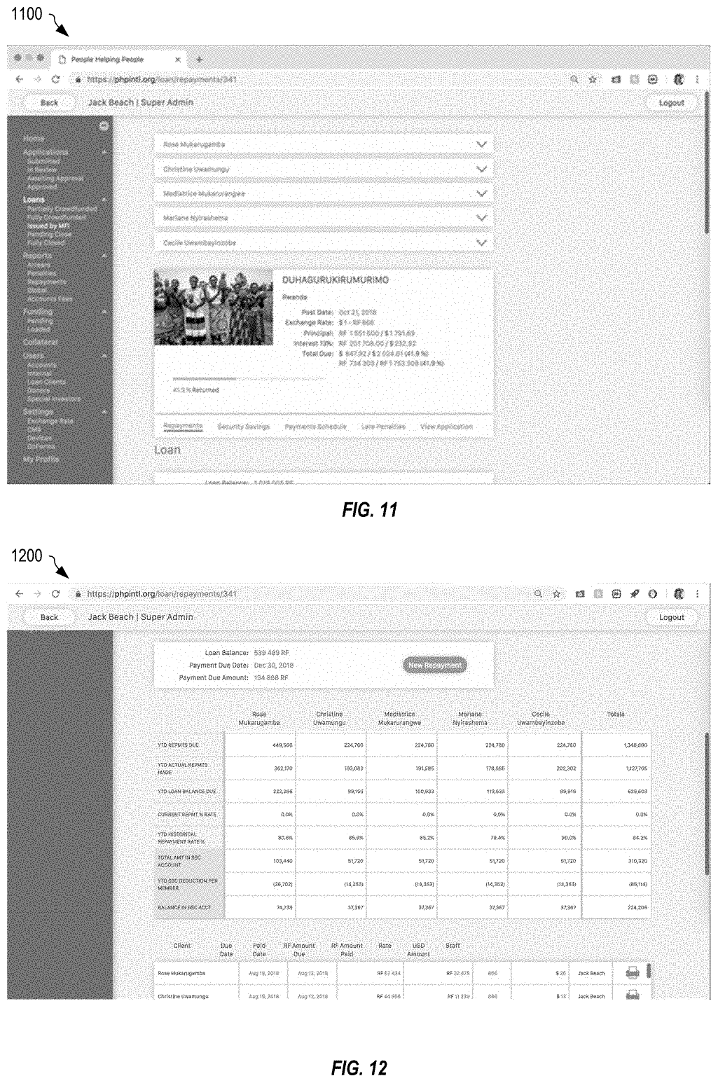

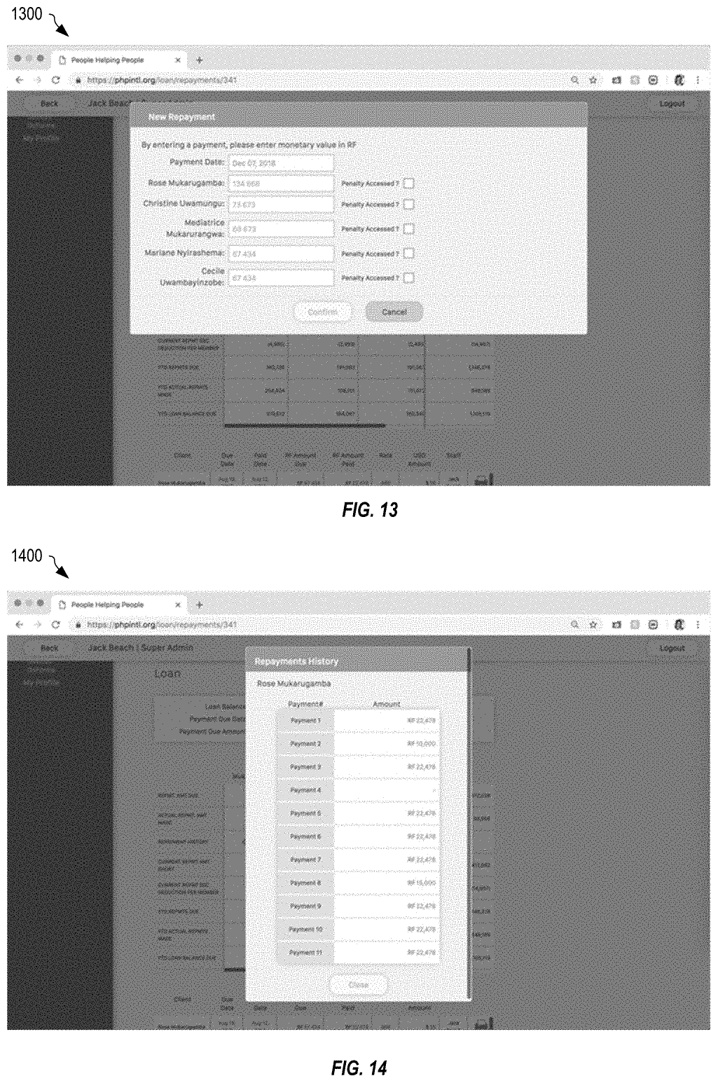

FIGS. 11 and 12 are screenshots 1100 and 1200, respectively, of a loan repayment page that may be displayed once the corresponding loan has issued. FIG. 13 is a screenshot 1300 showing a repayment pop-up that allows loan administrator 114 (e.g., or a teller) to enter repayment details for the corresponding loan. In this example, the loan was made to five individuals, that are each responsible for making repayments. FIG. 14 is a screenshot 1400 of a repayment history pop-up box that displays a history of repayments made by one of the individuals for this loan. In this example, payment 4 was missed.

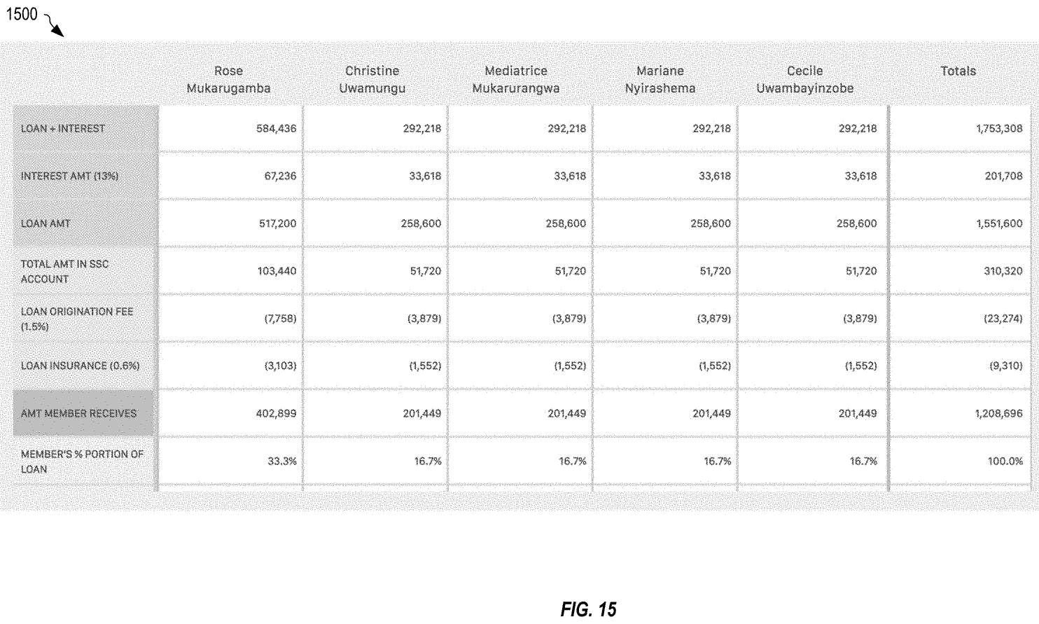

FIGS. 15-17 are screenshots 1500, 1600, and 1700, respectively, showing example detail of the repayment metrics for the loan.

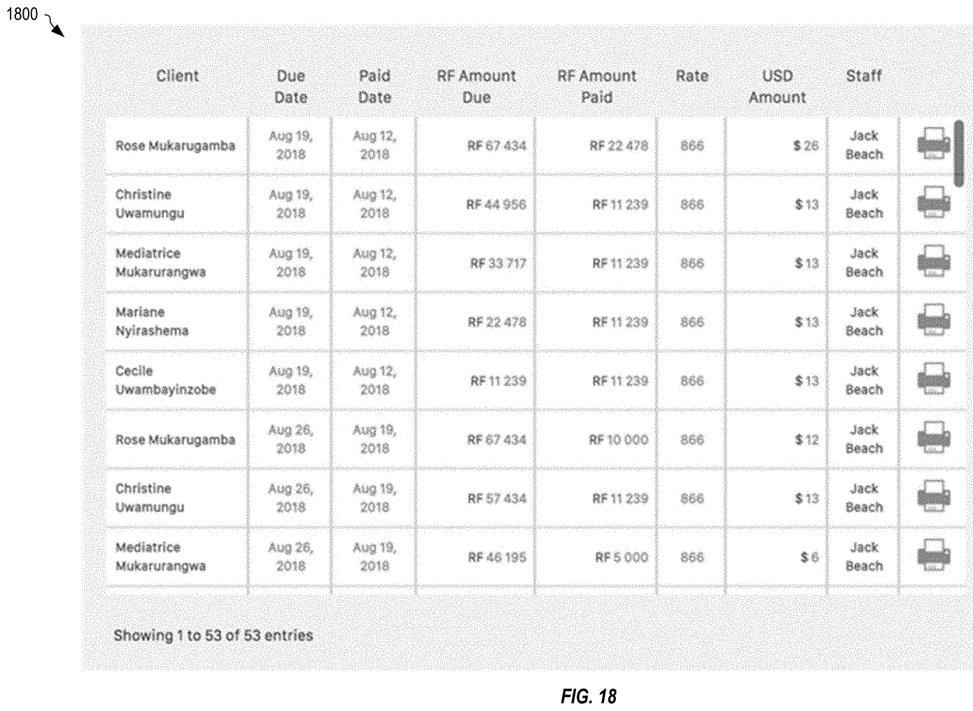

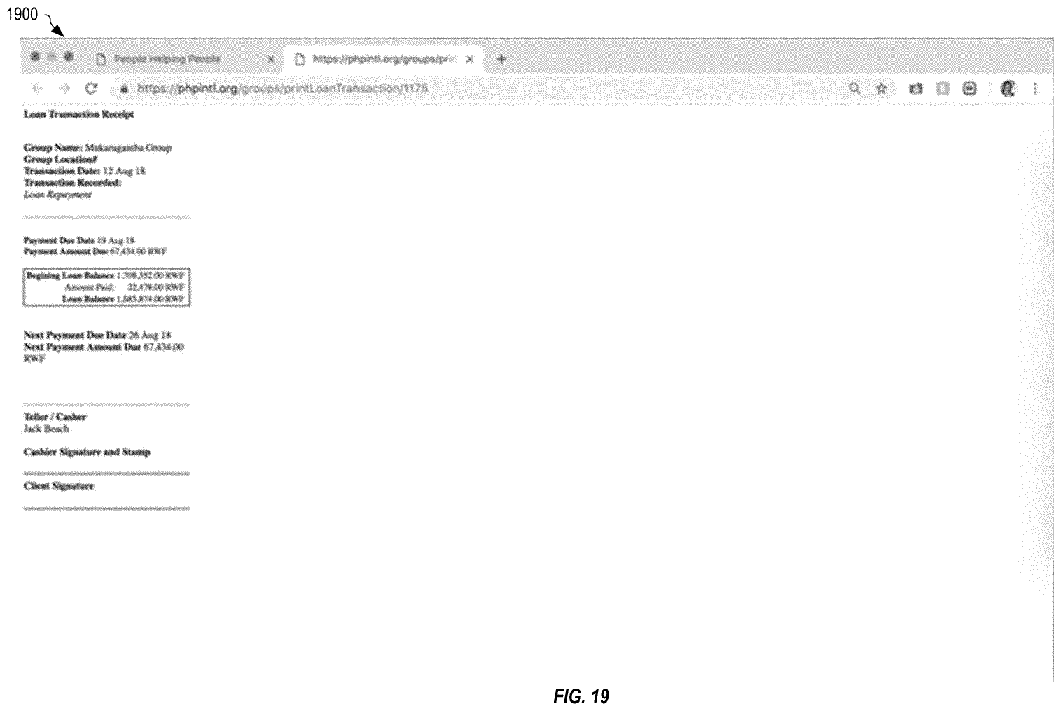

FIG. 18 is a screenshot 1800 showing a table of historical records for each repayment made to the corresponding loan. When the “print” icon (right-hand column) on the historical repayment table is selected for an individual member on a specific date, this record is output to the screen, as shown in the screenshot 1900 example of FIG. 19, and may be output to a local printer (e.g., a thermal printer), signed, stamped, and provided to each client in the group as a record of the repayment.

System 100 provides transparency of loan information to clients of both non-profit organizations, large foundations, such as The Ford Foundation, and large banks, such as Bank of New York Mellon's large offshore clients, enabling them to view, in real-time, where their investment funding is invested and/or donated. More importantly, the clients may view exactly how much has been paid back to date together with its percentage of the total amount due. This transparency allows the client to make decisions on funding, such as shutting down funding to a particular loan administrator 114 (e.g., a particular MFI) when payback of the loan is poor, at least until the repayment rate is sufficient.

System 100 also allows investor 106 to audit funding it has provided to loan administrators 114 by displaying payback records for all of the loans that the non-profit organization has funded for the investor/donor. System 100 allows the non-profit organization to audit its funds using a laptop in their office, without needing to have an auditor travel to the region where the loan has been provided (e.g., Africa) to review an outdated paper trail of corresponding accounts.

System 100 may also prevent a loan administrator (e.g., an MFI) from applying for funding for loans that do not exist and then reporting poor or no payback to a non-profit organization funding the loan, by requiring that the loan administrator 114 include a unique national identification number of the borrower 118, issued by the country where the loan is requested, and picture of each borrower 118 applying for the loan. The transparency of system 100 allows a non-profit organization to validate the unique national identification number and the picture before funding the loan.

Advantageously, system 100 provides transparency into microfinance loans in developing nations to potential investors in other countries. Particularly, system 100 provides the type of transparency that many offshore client investors are looking for. Since system 100 clearly indicates where the loans provide a return on investment (ROI), system 100 provides potential access to large amounts of capital to fund these loans.

System 100 stores loan data 116, including applicant information such as numeric and visual identifiers (e.g., a photo and national identification number), and investment data 108 in database 110 of server 102 and provides a graphical user interface (e.g., dashboard) that allows potential investors 106 to transparently view loan activity. This transparency enables loan administrators, investors 106, and administrative staff of system 100, to monitor transactions in real-time as they are entered into database 110, vastly reducing opportunities for creation of “ghost” loan applicants and other fraudulent practices, which are hard to detect with conventional paper accounting systems employed by most loan administrators 114 in developing countries today.

System 100 may also handle funding from donations (from entities or individuals not looking to receive a return on investment). System 100 may display slightly different dashboards to donors as compared to those described above for investors. Donor funds are those which come into system 100 to be returned to fund future loans as an ever-growing fund pool. Investor funds may yield a return on investment (e.g., a 5% return) once loans are repaid by borrowers 118 and/or investees 120.

System 100 may utilize widgets 204 to display loans on any website. For example, banks and/or non-profit organizations may include widget 204 on a page of their website, and widget 204 communicates with server 102 and database 110 to retrieve and display details of the loan to potential investors. Thus, the potential investors or donor may see these loans for the first time on the non-profit website, and may interact, through the widget with the server 102 to enroll the donor/investor for donating and/or investing. Since the widget is connected to the database 110, the widget displays internally approved applications for funding (aka “crowdfunded”) on the Internet by donors and investors. System 100 advantageously allows developing nations to find funding for their clients' loans through non-profits and other organizations that use system 100 to provide complete transparency to potential investors on their own websites, which may already have donor- and investor-bases in place. System 100 may provide investors and/or donors with access to a dashboard that allows them to monitor/audit repayment performance rate in real-time for the loans they fund. System 100 may allow each investor to define a cutoff point where system 100 notifies loan administrators 114 when their repayment track record is poor and that funding will no longer be provided until the track record improves.

System 100 provides loan administrators 114 with an easy method for inputting loan applications using a mobile device (e.g., a tablet computer, a laptop computer, a smartphone, etc.) in the field or using a desktop computer in the office. System 100 may also include an application (e.g., an app) that runs on the mobile device that allows loan applications and repayments to be collected offline.

System 100 may also be configured to require a set amount of security savings collateral (SSC) 122 as part of the loan principal to increase the repayment percentage rate and reduce non-performing loans.

System 100 may allow repayment schedules to be customized (e.g., one repayment per month, four repayments per month on the 7^{th}, 14^{th}, 21^{st} and last day of each month, or other repayment schedules), and thus repayments are not limited to the common weekly repayment schedule.

System 100 may use a two-tiered approval process whereby the first approval is done by a manager and the second approval is done by someone vetting the application prior to posting it on the internet to market to investors/donors for crowdfunding.

Once the loan is approved, when the client comes to make a repayment, system 100 allows the teller to simply enter a repayment amount made by the borrower and/or group members and system 100 calculates all other statistics regarding the loan automatically, eliminating errors.

When an underpayment occurs for one member within a group, system 100 may automatically make up the amount due by debiting corresponding SSC accounts for all members of the group proportionately to each member's percent equity in the loan. When the members' SSC accounts are exhausted paying for defaulting members, then system 100 may assess a penalty fee from that point on. This method may be invoked automatically, may be invoked by loan administrators 114, or may be turned off such that another method be used for accountability. System 100 is also flexible and may allow use of a special calculation or formula when requested by the loan administrator.

Loan administrators 114 may require a leader of a group applying for a loan to provide 2.5 times the principal value of their portion of the loan as additional collateral, since they are getting a larger portion of the group loan. System 100 allows a scan of the collateral documentation assigned to the loan to be uploaded and stored in database 110 to allow easy retrieval and prevent loss.

As a loan reaches its closing date, system 100 may notify the corresponding loan administrator 114 to deposit the total principal amount funded by investors and/or donors into an account of the non-profit funding the loan for the investor/donor. When the loan repayment is not 100%, then the loan administrator (e.g., WI) must make up the difference from interest collected on the loan. When a portion of any loan is funded by a large investor, then the total principal portion that the large investor funded plus a return on investment (ROI) (e.g., 5%) should be deposited to the non-profit that funded the loan for the investor. When loan administrator 114 does not wish to utilize large investors that require a 5% ROI (and thereby forfeit use of the crowdfunding feature of system 100) then the loan administrator may fund all of the loan, or allow non-profit small donors (that may not require any ROI) to fund the loan, such that only the principal has to be repaid to the non-profit small donors.

Use of system 100 may not require a large upfront software purchase payment, as system 100 may be provided on a reasonable monthly subscription fee basis. The subscription fee may be calculated as a percentage (e.g., between 0.5-0.9%) of the MFI's/SACCO's loan portfolio. It will be the same percentage for each MFI/SACCO using the system so that MFIs/SACCOs with small total loan portfolios at the end of each month will pay less than the MFIs/SACCOs with larger loan portfolios.

Clients who do not have the resource base to conduct auditing or to build out their own crowdfunding application may opt to use the widget to display the loans, and/or projects, directly on any page of their website. The benefit of using the widget is that loans and projects (posted for funding by loan administrators 114) may be displayed on websites of various private companies, non-profit organization, research institutions and the like who may already have a donor and/or investor base in place, thereby offering the loans and projects to a much larger potential audience for funding to MFIs/SACCOs.

A monthly subscription fee may be charged for use of widget 204, and system 100 may provide a dashboard graphical user interface to allow the subscriber to access analytics of funding occurring through use of the widget.

Donations and investments obtained through the widget and notify the non-profit as to the funding amount needed to be deposited into the MFI's/SACCO's bank account. When the loans are repaid, system 100 may also instruct the MFI/SACCO as to the amount that should be deposited into the non-profits bank account.

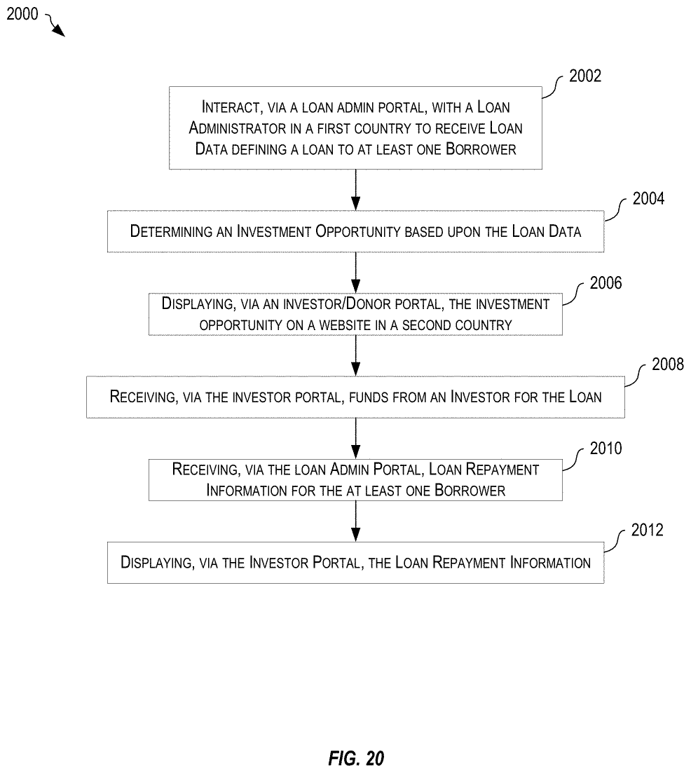

FIG. 20 is a flowchart illustrating one example method 2000 for transparent international crowdfunding. Method 2000 is for example implemented in server 102 of FIG. 1.

In block 2002, the server interacts, via loan administrator portal, with a loan administrator in a first country to receive loan data defining a loan to at least one borrower. In one example of block 2002, server 102 interacts, via loan administrator portal 112, with loan administrator 114 in a first country 206 to receive loan data 116 defining a loan to borrowers 118(1) and 118(2). In block 2004, the server determines an investment opportunity based upon the loan data. In one example of block 2004, investor portal 104 determines investment opportunities 402(1) and 402(2) based upon loan data 116, as entered on screenshots of FIGS. 6-10 for example. In block 2006, the server displays, via an investment portal, the investment opportunity on a website in a second country. In one example of block 2006, investor portal 104 interacts with widgets 204 to display investment opportunities 402(1) and 402(2) on websites 202(1) and 202(2) in second country 208. In block 2008, the server receives, via the investor portal, funds from an investor for the loan. In one example of block 2008, investor portal 104 receives funds from investor 106(2) when plant a seed button 404 is selected. In block 2010, the server receives, via the loan administrator portal, loan repayment information for the at least one borrower. In one example of block 2010, loan administrator portal 112 interacts with loan administrator 114(2) (or an authorized teller) to receive information of repayments made by each of borrowers 118(1) and 118(2) for the loan. In block 2012, the server displays, via the investor portal, the loan repayment information. In one example of block 2012, investor portal 104 displays screenshots of FIG. 5 to investor 106(1), allowing investor 106(1) to view details of repayments on the loan by borrowers 118(1) and 118(2).

A transparent method which for the first time enables a non-profit organization based in one country to see the actual repayment performance for all loans it has provided funding to a micro finance institution in another country. The repayment performance information may be accessed on the non-profit organization's computer located in a distant country at any point in time (real time). The method will enable the non-profit organization to vastly reduce its onsite audit time required in the absence of this method. The method will also provide for the first time the same transparency and loan repayment performance achieved by a micro finance institution for only those specific loans that the donors and investors have chosen to fund through the non-profit organization. The method includes a capability to offer the software functionality to website front-end clients, such as non-profit organizations, research institutions, foundations, banks and private companies, who may have their own websites and utilize the crowdfunding method via an embeddable widget provided the software provider to display loans for funding on their own websites. The software provider acts as an entity that connects donors, investors via an embedded widget on various front-end client's websites to loan client borrowers in other locations around the world via loan administrators (e.g., an administrator at a financial institution, such as a bank, a micro-financial institution (MFI), a savings and credit cooperative (SACCO), a credit union, etc.) who are using the software to store their loan client borrowers loan data. The software stores debit and credit transactions in a cloud-based server and displays that data via an analytics graphical user interface to lenders and loan administrators on behalf of borrowers. The software displays financial analytics, including client repayment performance, for loan portfolio management to loan portfolio administrators.

### Crowdfunding Banks

Another aspect of the present embodiments includes the realization that some financial institutions (e.g., banks, credit unions, etc.) in third world countries are using loan management servers and loan management software (e.g., software from third party software companies) to manage loans locally at the financial institution, and that these servers and software are already known to, and functioning well for, the financial institutions. Accordingly, the financial institutions are less willing to switch to, and learn, new loan management software (e.g., loan administrator portal 112). The present embodiments solve this problem by providing an Application Programming Interface (API) to push and pull loan information from financial institution loan management servers, and by allowing investors to directly fund one or more financial institutions, which in turn may then use the fund to provide local loans.

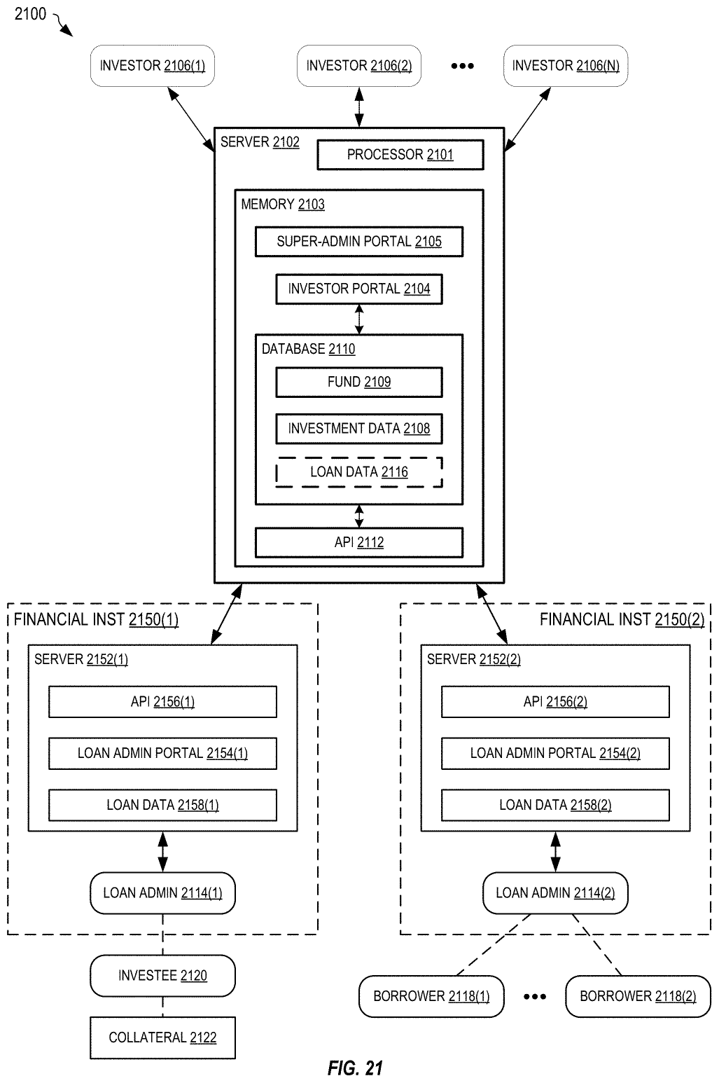

FIG. 21 shows one example system 2100 for transparent international crowdfunding. System 2100 is similar to system 100 of FIG. 1. System 2100 includes a server 2102 implemented within the cloud (e.g., connected to and accessible via, the Internet) that includes at least one processor 2101 and memory 2103. The memory 2103 stores machine-readable instructions (e.g., software) that when executed by the processor 2101 implement a super-admin portal 2105 for interacting with a super-admin user, an investor portal 2104 for interacting with investors 2106 (and potential investors) to collect and store investment data 2108 in a database 2110. In certain embodiments, the investor portal 2104 may implement a web interfaces and/or web site that are accessible via the Internet 124, for example.

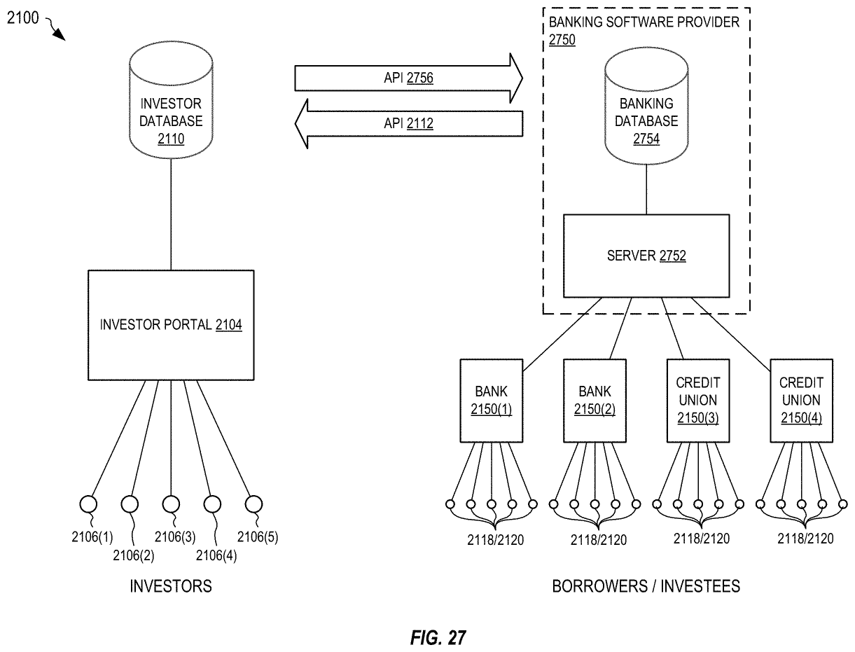

A financial institution 2150 (e.g., a bank, a micro-financial institution (MFI), a savings and credit cooperative (SACCO), a credit union, etc.) in a third world country has a loan administrator 2114 who uses a loan administrator portal 2154, running on server 2152, to collect corresponding loan data 2158 and manage local loans for one or more borrowers 2118 and/or investees 2120 (with collateral 2122). In certain embodiments, server 2152 may be operated by financial institution 2150 and use loan administrator portal 2154 (e.g., software) of a third party. In other embodiments, as shown in FIG. 27, server 2152 may be implemented within the cloud (e.g., connected to and accessible via, the Internet) by a third party. Accordingly, system 2100 does not directly implement a loan administrator portal and loan administrators 2114 are not required to directly interact with server 2102.

Server 2102 and server 2152 use APIs 2112 and 2156, respectively, to communicate and transfer loan data 2158 to server 2102 where it may be stored in database 2110 as loan data 2116. Advantageously, loan administrator 2114 at financial institution 2150 has no need to learn and use a loan administrator portal of server 2102, since loan administrator 2114 continues to administer loans for financial institution 2150 through loan administrator portal 2154. However, through use of APIs 2112 and 2156, loan data 2158 is accessible by server 2102.

Within system 2100, investor portal 2104 may use certain information of loan data 2116 to provide a transparent inventor dashboard to investors 2106 by showing details of financial institution 2150 corresponding to the fund 2109. Thus, system 2100 makes the investor dashboard more transparent to investor 2106 as compared to conventional crowdfunding systems. In one example, system 2100 aggregates loan data 2116 for each financial institution 2150 such that investors 2106 see performance of each financial institution 2150 and may thereby decide whether to invest in one or more financial institutions. Accordingly, investor 2106 may view performance details of how financial institution 2150 manages borrower 2118 and investee 2120, which may be invaluable for securing an investment from investor 2106, particularly when investor 2106 and financial institution 2150 are in different countries. Through use of server 2102 to more readily secure investment (e.g., fund 2109) for financial institution 2150, financial institution 2150 may create new loan products that lower the interest rate for borrowers 2118 and investees 2120.

In one example of operation, loan data 2116 may include a request for fund 2109 from financial institution 2150 for funds. System 2100 allows a super-admin to review loan data 2116, and where loan data 2116 is acceptable, a corresponding fund 2109 may be created and fulfilled, through investor portal 2104, by one or more investors 2106. The following screenshots illustrate example transparency of information provided by system 2100 to investors 2106.

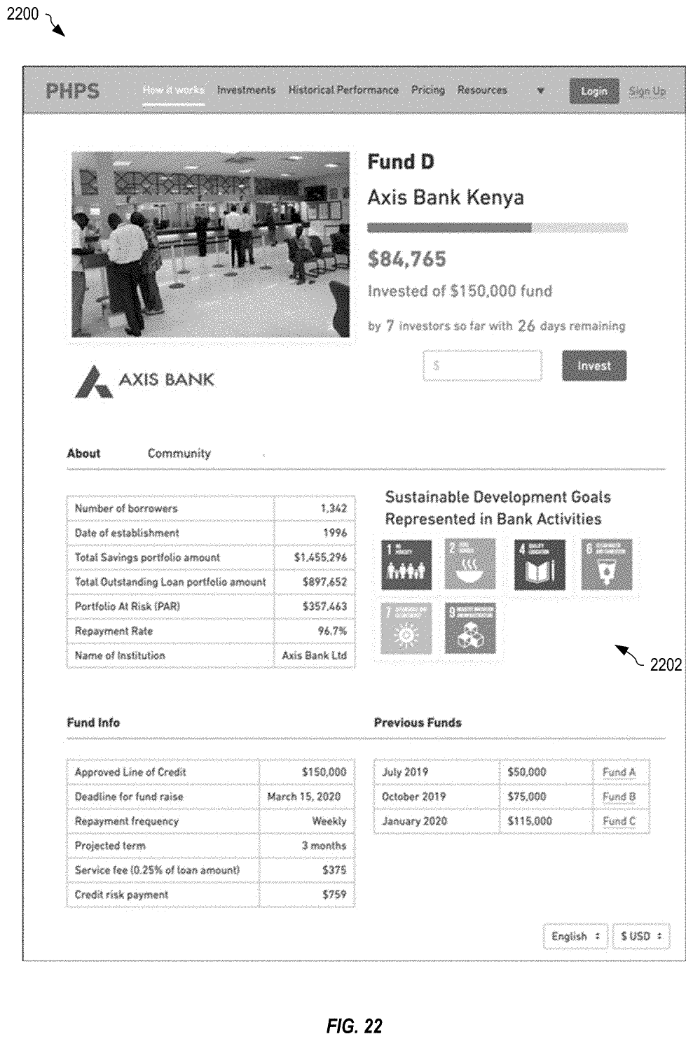

FIG. 22 is an example screenshot 2200 generated by investor portal 2104 of FIG. 21, showing the details of one financial institution 2150 to be funded by online investors 2106. Investors 2106 may view specifications about of financial institution 2150 and its prior performance as a prerequisite to investing in a fund 2109 (e.g., Fund D). Although screenshot 2200 illustrates funding at the financial institution-level, loan-level funding may still be available to investor 2106, whereby specific details of loan data 2158 (retrieved via APIs 2112 and/or 2156) may be displayed by investor portal 2104 when requested. In the example of FIG. 22, screenshot 2200 shows a component 2202 that displays connections to the United Nations Sustainable Development Goals of financial institution 2150 and its respective borrowers 2118 and investees 2120 in their activities, thereby allowing investors 2106 to select funds having social and environmental impact for their investment.

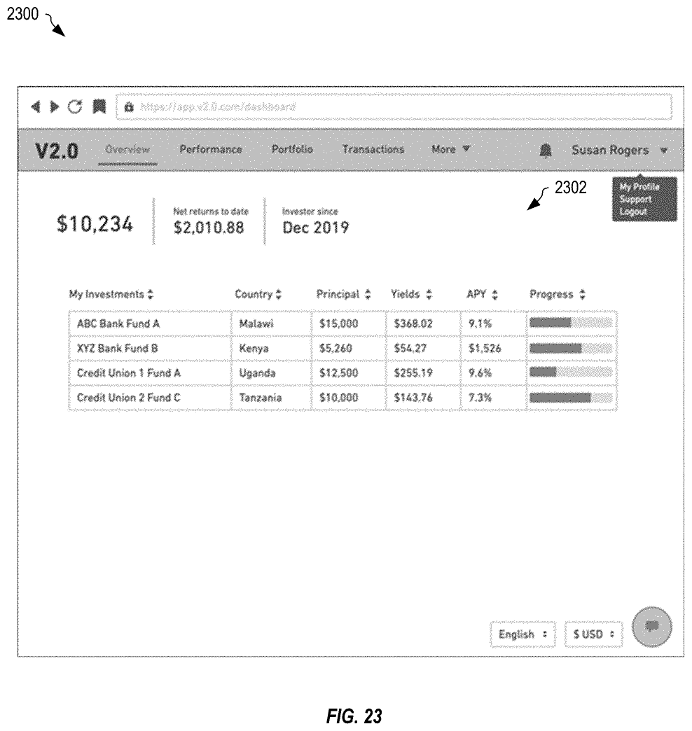

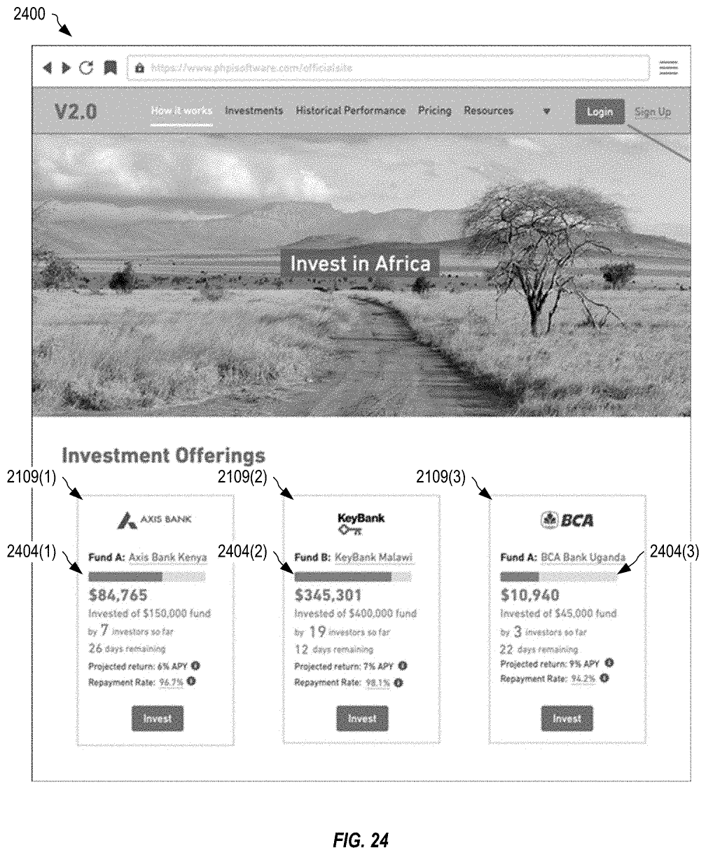

FIG. 23 is an example screenshot 2300, generated by investor portal 2104 of FIG. 21, showing an investor dashboard 2302 that conveys progress and performance of funds corresponding to investor 2106 (e.g., funds in which investor 2106 has invested). For example, when investor 2106 invests in a specific fund designated for financial institution 2150, investor dashboard 2302 automatically illustrates progress of financial institution 2150 repaying the fund along with the predetermined investor return on investment. Note that the financial institution location is displayed by Country and is not limited to one specific physical location within the country.

FIG. 24 is an example landing page 2400, generated by investor portal 2104 of FIG. 21, displaying three financial institution-level funds 2109(1)-(3) being marketed to investors 2106 (e.g., requesting investment by investors 2106). For each respective fund 2109(1)-(3), a trackbar 2404(1)-(3) indicates fundraising progress. Each respective fund 2109(1)-(3) provides investors 2106 with a projected return and repayment rate on the investment to enable investors 2106 to easily choose one or more funds 2109 for investment.

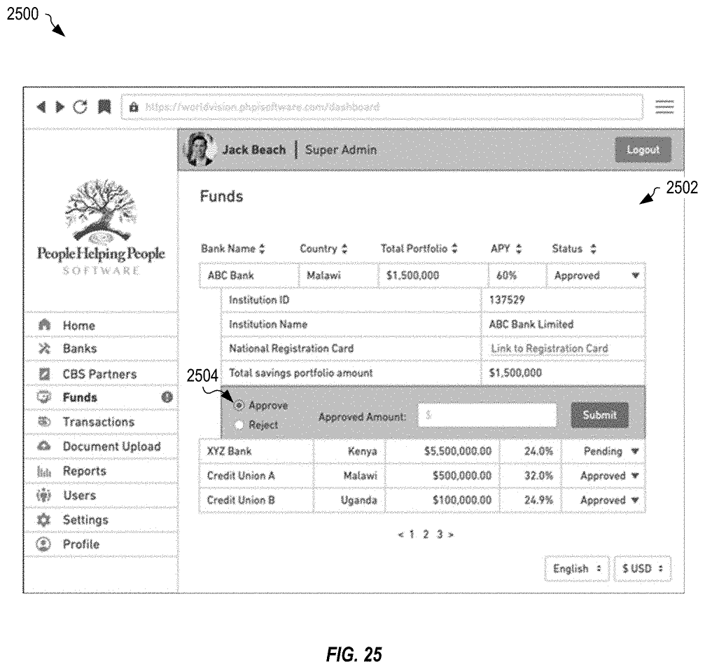

FIG. 25 is an example screenshot 2500, generated by super-admin portal 2105, showing a super-admin dashboard 2502 illustrating approval 2504 of a fund 2109 applied for by the ABC bank in Malawi. The super-admin user represents a highest operational level of system 2100. In this example, server 2102 uses API 2112 to connect to servers 2152 to retrieve financial institution-level data, and therefore does not need to store and maintain such data within database 2110.

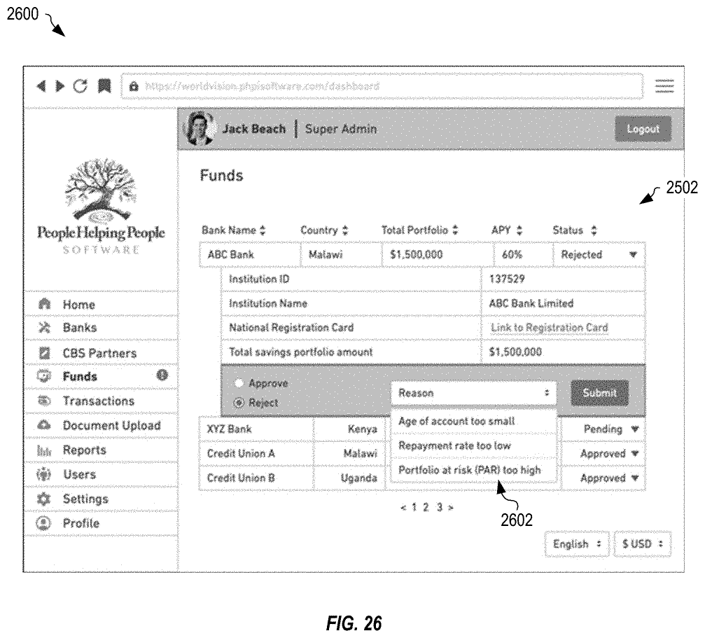

FIG. 26 is an example screenshot 2600, generated by super-admin portal 2105, showing super-admin dashboard 2502 of FIG. 25 illustrating rejection of the fund 2109 applied for by the ABC bank in Malawi. Super-admin dashboard 2502 further illustrates reason options 2602 that are selectable by the super-admin user to notify the ABC bank why their fund application was rejected.

FIG. 27 is a high-level block diagram of system 2100 interfacing with a banking software provider 2750 to fund loans through one or more financial institutions 2150. Banking software provider 2750 is for example a third-party software developer that uses at least one server 2752 to provide banking software services to a plurality of financial institutions 2150 located in at least one third world country. In the example of FIG. 27, banking software provider 2750 implements a cloud based server 2752 that is accessible by financial institution 2150. Advantageously, a partnership between system 2100 and banking software provider 2750 benefits financial institution 2150. Through use of APIs 2112 of server 2102 and an API 2756 in server 2752 of banking software provider 2750, financial institution 2150 may submit funding requests to system 2100, via server 2752 of banking software provider 2750. The super-admin may then create a fund 2109 (see FIG. 21) such that investor portal 2104 allows one or more investors 2106 to fulfil fund 2109 to allow financial institution 2150 to provide loans to at least one borrower 2118 and/or investee 2120.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween. In particular, the following embodiments are specifically contemplated, as well as any combinations of such embodiments that are compatible with one another:

(A) A system for transparent international crowdfunding of loans by a financial institution, includes: at least one processor; a memory, communicatively coupled with the processor; an investor portal, having machine-readable instructions stored in the memory and executed by the processor, that causes the processor to: receive loan data from a server of the financial institution in a first country via an application programming interface (API); determine a fund based upon the loan data; implement a web interface, displaying details of the fund, that is accessible via the Internet by at least one investor in a second country, different from the first country; and receive an investment for the fund from the at least one investor.

(B) In the system denoted as (A), the first country being a third world country and the financial institution being one of a micro-financial institution (MFI), a savings and credit cooperative (SACCO), and a credit union.

(C) In either of the systems denoted as (A) and (B), the details of the fund indicating connections to the United Nations Sustainable Development Goals of (a) activities of the financial institution and (b) activities of respective borrowers and investees.

(D) In any of the systems denoted as (A)-(C), the details of the fund including performance information of past funds made to the financial institution.

(E) In any of the systems denoted as (A)-(D), the details of the fund including one or more of a deadline for raising the fund, a repayment frequency, a projected term of the fund, and a service fee amount.

(F) In any of the systems denoted as (A)-(E), the details of the fund including information of the financial institution including one or more of a number of borrowers, a date of establishment, a total savings portfolio amount, a total outstanding loan portfolio amount, a portfolio at risk value, and a repayment rate.

(G) In any of the systems denoted as (A)-(F), the loan data defining a requested loan amount and identifying at least two borrowers, each responsible for a different sized portion of the requested loan amount.

(H) In any of the systems denoted as (A)-(G), the investor portal further including machine-readable instructions, stored in the memory, that, when executed by the processor, cause the processor to: receive, via the API, loan repayment information for each loan using the fund; and display, via the web interface, performance data of the fund based upon the loan repayment information.

(I) A method for transparent international crowdfunding, including: receiving, via an application programming interface (API) implemented as machine-readable instructions executed by a processor of a server, loan data defining a loan amount and identifying at least one borrower responsible for the loan amount; displaying, via an investor portal implemented as machine-readable instructions executed by the processor, the investment opportunity on a website in a second country; receiving, via the investor portal, funds from an investor for the loan; receiving, via the API, loan repayment information for the at least one borrower; displaying, via the investor portal, the loan repayment information; and displaying, via the investor portal, performance statistics of the loan administrator.

(J) The method denoted as (I), further including determining an investment opportunity based upon the loan data.

(K) Either of the methods denoted as (I) and (J), further including receiving, via the API, numeric and visual identifiers of the at least one borrower, wherein the numeric and visual identifiers may be compared to validate the loan.

(L) A method for transparently enabling a non-profit organization based in a first country to view loan repayment information and loan performance information for a loan funded by the non-profit organization through a financial institution in a second country, including: receiving, via an application programming interface (API) implemented as machine-readable instructions executed by a processor of a server, loan data including the loan repayment information of at least one borrower associated with the loan; displaying, via an investor portal implemented as machine-readable instructions executed by the processor, the loan repayment information on a website accessible by the non-profit organization; calculating the loan performance information using the loan data and the loan repayment information; and displaying, via the investor portal, the loan performance information. The loan repayment information and the loan performance information being accessible at any point in time, including in real time, on a computer of the non-profit organization located in the first country.

(M) The method denoted as (L), further including providing an embeddable widget that, when used on a webpage of a front-end client, implements crowdfunding by displaying information of loans waiting for funding on the webpage and allowing a viewer of the webpage to connect with the non-profit organization.

(N) In either of the methods denoted as (L) and (M), the front-end client being one of the non-profit organization, a research institution, a foundation, a bank, and a private company.

What is claimed is:

1. A system for transparent international crowdfunding of loans by a financial institution, comprising:
at least one processor;
a memory, communicatively coupled with the processor;
an investor portal, having machine-readable instructions stored in the memory and executed by the processor, that causes the processor to:
receive loan data from a server of the financial institution in a first country via an application programming interface (API);
determine a fund based upon the loan data;
implement a web interface, displaying details of the fund, that is accessible via the Internet by at least one investor in a second country, different from the first country; and
receive an investment for the fund from the at least one investor.

2. The system of claim 1, wherein the first country is a third world country and the financial institution is one of a micro-financial institution (MFI), a savings and credit cooperative (SACCO), and a credit union.

3. The system of claim 1, the details of the fund indicating connections to the United Nations Sustainable Development Goals of (a) activities of the financial institution and (b) activities of respective borrowers and investees.

4. The system of claim 1, the details of the fund comprising performance information of past funds made to the financial institution.

5. The system of claim 1, the details of the fund comprising one or more of a deadline for raising the fund, a repayment frequency, a projected term of the fund, and a service fee amount.

6. The system of claim 1, the details of the fund including information of the financial institution including one or more of a number of borrowers, a date of establishment, a total savings portfolio amount, a total outstanding loan portfolio amount, a portfolio at risk value, and a repayment rate.

7. The system of claim 1, the loan data defining a requested loan amount and identifying at least two borrowers, each responsible for a different sized portion of the requested loan amount.

8. The system of claim 1, the investor portal further comprising machine-readable instructions, stored in the memory, that, when executed by the processor, cause the processor to:
receive, via the API, loan repayment information for each loan using the fund; and
display, via the web interface, performance data of the fund based upon the loan repayment information.

9. A method for transparent international crowdfunding, comprising:
receiving, via an application programming interface (API) implemented as machine-readable instructions executed by a processor of a server, loan data defining a loan amount and identifying at least one borrower responsible for the loan amount;
displaying, via an investor portal implemented as machine-readable instructions executed by the processor, the investment opportunity on a website in a second country;
receiving, via the investor portal, funds from an investor for the loan;
receiving, via the API, loan repayment information for the at least one borrower;
displaying, via the investor portal, the loan repayment information; and
displaying, via the investor portal, performance statistics of the loan administrator.

10. The method of claim 9, further comprising determining an investment opportunity based upon the loan data.

11. The method of claim 9, further comprising receiving, via the API, numeric and visual identifiers of the at least one borrower, wherein the numeric and visual identifiers may be compared to validate the loan.

12. A method for transparently enabling a non-profit organization based in a first country to view loan repayment information and loan performance information for a loan funded by the non-profit organization through a financial institution in a second country, comprising:
receiving, via an application programming interface (API) implemented as machine-readable instructions executed by a processor of a server, loan data including the loan repayment information of at least one borrower associated with the loan;
displaying, via an investor portal implemented as machine-readable instructions executed by the processor, the loan repayment information on a website accessible by the non-profit organization;
calculating the loan performance information using the loan data and the loan repayment information; and
displaying, via the investor portal, the loan performance information;
wherein the loan repayment information and the loan performance information is accessible at any point in time, including in real time, on a computer of the non-profit organization located in the first country.

13. The method of claim 12, further comprising providing an embeddable widget that, when used on a webpage of a front-end client, implements crowdfunding by displaying information of loans waiting for funding on the webpage and allowing a viewer of the webpage to connect with the non-profit organization.

14. The method of claim 13, wherein the front-end client is one of the non-profit organization, a research institution, a foundation, a bank, and a private company.
